(19) United States
(12) Patent Application Publication
(10) Pub. No.: US 2010/0136219 A1
(43) Pub. Date: Jun. 3, 2010

(54) METHOD FOR MANUFACTURING PLASMA DISPLAY PANEL

(76) Inventors: Yuichiro Miyamae, Osaka (JP); Kazuhiro Yokota, Hyogo (JP); Shinichiro Ishino, Osaka (JP); Koyo Sakamoto, Osaka (JP); Kaname Mizokami, Kyoto (JP); Hideji Kawarazaki, Osaka (JP); Yoshinao Ooe, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/596,000

(22) PCT Filed: Mar. 6, 2009
(86) PCT No.: PCT/JP2009/001022

§ 371 Date: Oct. 15, 2009

(30) Foreign Application Priority Data
Mar. 12, 2008 (JP) 2008-062159

(51) Int. Cl. B05D 5/12

(52) U.S. Cl. 427/66

(57) ABSTRACT

According to the method for manufacturing a plasma display panel, the protective layer is formed by the following process: evaporating a base-coat film for the protective layer onto the dielectric layer; forming crystal-particle paste on the base-coat film by applying crystal-particle paste in which a plurality of crystal particles of metal oxide is dispersed in a solvent classified into any one of an aliphatic alcohols solvent having ether binding and an alcohols solvent larger than dihydric alcohol; and removing the solvent by heating the crystal-particle paste film so that the plurality of crystal particles are distributed over the entire surface of the protective layer.

### TECHNICAL FIELD

The present invention relates to a method for manufacturing a plasma display panel used for display devices.

### BACKGROUND ART

A plasma display panel (hereinafter referred to as a PDP) has been employed for 65-inch class TVs from the advantages of attainability of higher definition and a larger size of the screen. In recent years, a PDP has expanded its applicability to a high definition TV that has twice scan lines or more than twice as many scan lines as in the TVs on the conventional NTSC system. At the same time, there has been growing demand for a lead-free PDP from the standpoint of environmental protection.

Basically, a PDP is formed of a front plate and a rear plate. The front plate has a glass substrate made of sodium borate/silicate glass made by float method, display electrodes formed of transparent electrodes and bus electrodes arranged in stripes on one principal surface of the glass substrate, a dielectric layer that covers the display electrodes and serves as a capacitor, and a protective layer that is made of magnesium oxide (MgO) and is disposed over the dielectric layer. On the other hand, the rear plate has a glass substrate, address electrodes arranged in stripes on one principal surface of the glass substrate, a base-coat dielectric layer that covers the address electrodes, barrier ribs formed on the base-coat dielectric layer, and phosphor layers formed between the barrier ribs and each of the phosphor layers emits light in red, green, and blue.

The front plate and the rear plate are hermetically sealed, with each side having the electrodes oppositely disposed. The discharge space between the two plates is divided by the barrier ribs and filled with Ne—Xe discharge gas with a charged pressure of 400 Torr to 600 Torr. In the operation of a PDP, image signal voltage is applied selectively to the display electrodes, by which a discharge occurs. The discharge generates ultraviolet light, which excites the phosphor layers to have light emission of red, green, and blue. The PDP thus provides color image display (see patent document 1).

patent document 1: Japanese Unexamined Patent Application Publication No. 2007-48733

### SUMMARY OF THE INVENTION

The present invention discloses a method for manufacturing a PDP. A PDP has a front plate and a rear plate disposed opposite to the front plate so as to form discharge space therebetween. The front plate has a dielectric layer that covers display electrodes formed on a substrate, and a protective layer formed over the dielectric layer. The rear plate has address electrodes, which are formed so as to be orthogonal to the display electrodes, and barrier ribs for dividing the discharge space. According to the method, the protective layer is formed through the following process. After a base-coat film is evaporated onto the dielectric layer, crystal-particle paste is applied to the base-coat film to form a crystal-particle-paste film. The crystal-particle paste has a plurality of crystal particles of metal oxide dispersed in any one of an aliphatic alcohols solvent having ether binding and an alcohols solvent larger than dihydric alcohol. The crystal-particle-paste film is then heated so that the solvent is removed from the film. As a result, a plurality of crystal particle is dispersed all over the protective layer.

### BRIEF DESCRIPTION OF THE DRAWINGS

FIG. 1 is a perspective view showing the structure of a PDP in accordance with an exemplary embodiment of the present invention.

FIG. 2 is a section view showing the structure of the front plate of the PDP in accordance with the exemplary embodiment of the present invention.

FIG. 3 is an enlarged view showing the protective layer in accordance with the exemplary embodiment of the present invention.

FIG. 4 is an enlarged view showing agglomerated particles dispersed on the protective layer of the PDP in accordance with the exemplary embodiment of the present invention.

FIG. 5 shows the result of cathode luminescence measurement of a crystal particle.

FIG. 6 shows relationship between electron emission characteristic and Vscn lighting voltage as a result of the experiment for demonstrating the effectiveness of the present invention.

FIG. 7 shows relationship between a particle diameter of the crystal particle and electron emission characteristic.

FIG. 8 shows relationship between a particle diameter of the crystal particle and breakage ratio of the barrier ribs.

FIG. 9 shows an example of particle size distribution of the crystal particle in the PDP in accordance with the exemplary embodiment of the present invention.

FIG. 10 shows the steps of forming the protective layer in the method for manufacturing a PDP in accordance with the exemplary embodiment of the present invention.

FIG. 11 shows a result of the experiment on dispersibility of MgO crystal particles when the crystal particles are dispersed in paste with use of various types of solvent.

REFERENCE MARKS IN THE DRAWINGS

| | |
|---|---|
| 1 | PDP |
| 2 | front plate |
| 3 | front glass substrate |
| 4 | scan electrode |
| 4a, 5a | transparent electrode |
| 4b, 5b | metallic bus electrode |
| 5 | sustain electrode |
| 6 | display electrode |
| 7 | black stripe (light-shielding layer) |
| 8 | dielectric layer |
| 9 | protective layer |
| 10 | rear plate |
| 11 | rear glass substrate |
| 12 | address electrode |
| 13 | base-coat dielectric layer |
| 14 | barrier rib |
| 15 | phosphor layer |
| 16 | discharge space |
| 81 | first dielectric layer |
| 82 | second dielectric layer |
| 91 | base-coat film |
| 92 | agglomerated particle |
| 92a | crystal particle |

### DETAILED DESCRIPTION OF THE PREFERRED EMBODIMENTS

In a PDP, the protective layer formed on the dielectric layer of the front plate has the functions of protecting the dielectric layer from ion bombardment and of emitting an initial electron for generating an address discharge. Protecting the dielectric layer from ion bombardment is important in preventing increase in discharge voltage. Similarly, emitting an initial electron for generating an address discharge is important in preventing the failure of the address discharge that causes a flicker of images.

To reduce the flicker of images, manufacturers have made an attempt at increasing initial electron emission from the protective layer, for example, by adding Si and Al to MgO.

As the recent years' advance in high-definition TVs, there has been a growing demand of the market for a low-cost, low-power, high-luminance full HD (high definition) PDP (1920×1080 pixels, progressive display). Image quality of a PDP depends on electron emission from the protective layer; it is important to control the electron emission characteristic.

The present invention addresses the problem above and provides a low-power PDP with high-definition and high-luminance.

Hereinafter will be described a PDP in accordance with an exemplary embodiment of the present invention with reference to the drawings.

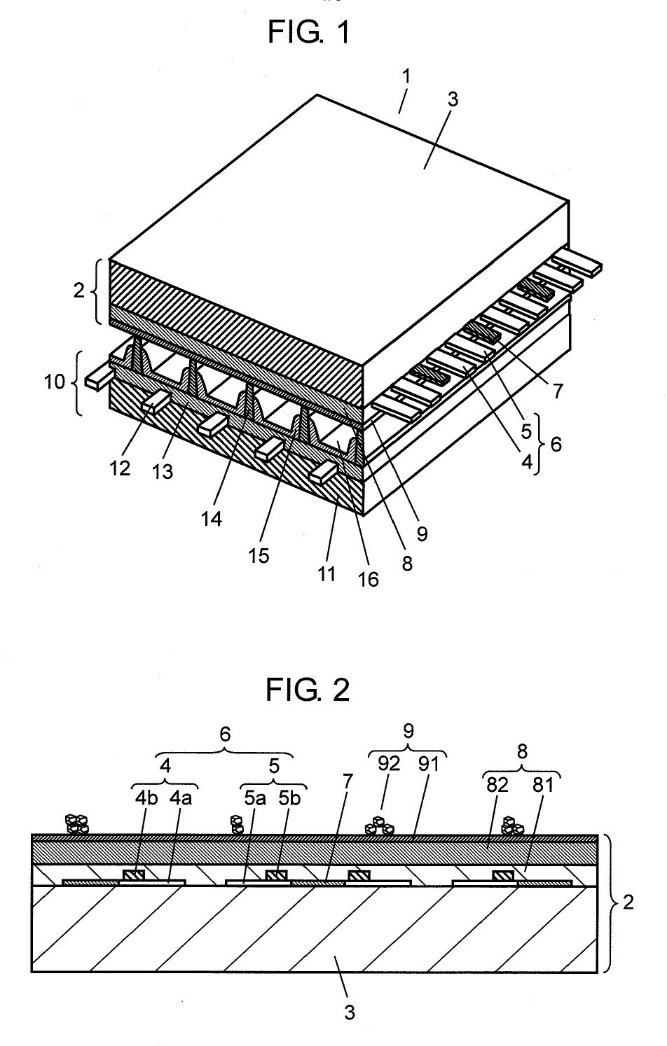

FIG. 1 is a perspective view showing the structure of a PDP in accordance with an exemplary embodiment of the present invention. The structure of a PDP is basically the same as that of a generally known AC type surface discharge PDP. As shown in PDP 1 of FIG. 1, front plate 2 having front glass substrate 3 is disposed opposite to rear plate 10 having rear glass substrate 11. The two plates are hermetically sealed at each outer periphery with sealing material made of glass frit or the like. Discharge space 16, which is formed between the sealed two plates of PDP 1, is filled with discharge gas, such as Ne and Xe, with a charged pressure of 400 Torr to 600 Torr.

On front glass substrate 3 of front plate 2, strip-shaped display electrodes 6, each of which is formed of scan electrode 4 and sustain electrode 5 in pairs, and black stripes (light-shielding layers) 7 are disposed in parallel. Dielectric layer 8, which serves as a capacitor, covers display electrodes 6 and light-shielding layers 7 on front glass substrate 3. Besides, protective layer 9 made of magnesium oxide (MgO) is formed on the surface of dielectric layer 8.

On rear glass substrate 11 of rear plate 10, a plurality of strip-shaped address electrodes 12 are disposed in parallel with each other in a direction orthogonal to scan electrodes 4 and sustain electrodes 5 on front plate 2. Base-coat dielectric layer 13 covers address electrodes 12. Besides, barrier ribs 14 with a predetermined height as a divider of discharge space 16 are formed between address electrodes 12 on base-coat dielectric layer 13. Phosphor layers 15, in which phosphors that emit red, green, and blue by ultraviolet light are sequentially applied, are disposed on groove between each of barrier ribs 14 and each of address electrodes 12. A discharge cell is formed at an intersection of a pair of scan electrodes 4 and sustain electrodes 5 and each of address electrodes 12. Each discharge cell containing phosphor layers 15—where phosphors red, green, and blue are arranged in a direction of display electrodes 6—constitutes a pixel for color image display.

FIG. 2 is a section view showing the structure of front plate 2 of PDP 1 in accordance with the exemplary embodiment of the present invention. FIG. 2 is an upside-down view of FIG. 1. As shown in FIG. 2, display electrodes 6 formed of scan electrodes 4 and sustain electrodes 5 and light-shielding layer 7 are formed by patterning on front glass substrate 3 that is formed by floating or the like. Each of scan electrodes 4 and sustain electrodes 5 is formed of transparent electrodes 4a, 5a and metallic bus electrodes 4b, 5b disposed on transparent electrodes 4a, 5a. Transparent electrodes 4a, 5a are made of indium tin oxide (ITO), tin oxide (SnO₂), and the like. Metallic bus electrodes 4b, 5b are made of conductive material containing silver (Ag) material as a major component, which allows transparent electrodes 4a, 5a to have conductivity in the lengthwise direction.

Dielectric layer 8 has at least two-layer structure of first dielectric layer 81 and second dielectric layer 82. First dielectric layer 81 covers transparent electrodes 4a, 5a, metallic bus electrodes 4b, 5b, and light-shielding layer 7 disposed on front glass substrate 3. Second dielectric layer 82 is disposed over first dielectric layer 81. Protective layer 9 is disposed over second dielectric layer 82. Protective layer 9 is formed of base-coat film 91, which is formed on dielectric layer 8, and agglomerated particles 92 attached on base-coat film 91.

Next will be described the method for manufacturing a PDP. First, scan electrodes 4, sustain electrodes 5, and light-shielding layer 7 are formed on front glass substrate 3. Transparent electrodes 4a, 5a and metallic bus electrodes 4b, 5b that constitute the electrodes 4 and 5 are formed by patterning of, for example, photolithography. Specifically, transparent electrodes 4a, 5a are formed by a thin-film process. As for metallic bus electrodes 4b, 5b, silver (Ag)-containing paste is baked at a predetermined temperature and then solidified. Light-shielding layer 7 is similarly formed in the following ways: paste containing black pigment is screen printed; or after black pigment is applied to all the surface of the glass substrate, it is processed by patterning of photolithography and then baked.

Next, a dielectric paste layer (dielectric material layer) is formed on front glass substrate 3 in a manner that dielectric paste is applied by die coating or the like so as to cover scan electrodes 4, sustain electrodes 5, and light-shielding layer 7. After the application of the dielectric paste, letting it stand for a predetermined period allows the paste to have a leveled surface. After that, the dielectric paste is baked and solidified. Through the process, dielectric layer 8 that covers scan electrodes 4, sustain electrodes 5, and light-shielding layer 7 is formed. The dielectric paste above is a coating material that contains dielectric material, such as glass powder, a binder, and a solvent.

Protective layer 9 of magnesium oxide (MgO) is formed on dielectric layer 8 by vacuum deposition. Through the steps above, predetermined components (i.e., scan electrodes 4, sustain electrodes 5, light-shielding layer 7, dielectric layer 8, and protective layer 9) are formed on front glass substrate 3. Front plate 2 is thus completed.

On the other hand, rear plate 10 is formed through the steps below. First, a metallic film is formed all over the surface of rear glass substrate 11 in a manner that silver (Ag)-containing paste is applied by screen printing. After that, the paste undergoes patterning of photolithography. A layer of material as a component of address electrodes 12 is thus formed. The layer of material is baked at a predetermined temperature and address electrodes 12 are completed. Next, a dielectric paste layer is formed on address electrodes 12 on rear glass substrate 11 in a manner that dielectric paste is applied by die coating or the like so as to cover address electrodes 12. After that, the dielectric paste layer is baked and base-coat dielectric layer 13 is completed. The dielectric paste above is a coating material that contains dielectric material, such as glass powder, a binder, and a solvent.

As the next step, a layer of material of the barrier ribs is formed on base-coat dielectric layer 13 in a manner that paste for forming barrier ribs is applied and formed into a predetermined shape by patterning. Such processed layer of material is baked and barrier ribs 14 are completed. Photolithography and sandblasting are employed for patterning paste for the barrier ribs applied on base-coat dielectric layer 13. Next, phosphor paste containing phosphor material is applied on base-coat dielectric layer 13 between adjacent barrier ribs 14 and on the side surfaces of barrier ribs 14. The paste is baked and phosphor layer 15 is completed. Through the steps above, predetermined components of rear glass substrate 11 are formed and rear plate 10 is completed.

Front plate 2 and rear plate 10, each of which has predetermined components thereon, are oppositely disposed in a manner that scan electrodes 4 are positioned orthogonal to address electrodes 12. The two plates are hermetically sealed at each outer periphery with glass frit. Discharge space 16 is filled with discharge gas containing, for example, Ne and Xe. PDP 1 is thus completed.

Here will be given detailed explanation on first dielectric layer 81 and second dielectric layer 82 of dielectric layer 8 disposed on front plate 2. The dielectric material of first dielectric layer 81 has the following material composition: 20 to 40 wt % bismuth oxide (Bi₂O₃); 0.5 to 12 wt % at least any one of calcium oxide (CaO), strontium oxide (SrO), and barium oxide (BaO); 0.1 to 7 wt % at least any one of molybdenum oxide (MoO₃), tungsten oxide (WO₃), cerium oxide (CeO₂), and manganese dioxide (MnO₂).

In the composition above, instead of the aforementioned group having molybdenum oxide (MoO₃), tungsten oxide (WO₃), cerium oxide (CeO₂), and manganese dioxide (MnO₂) from which at least any one is selected, the dielectric material of first dielectric layer 81 may contain at least any one of copper oxide (CuO), chrome oxide (Cr₂O₃), cobalt oxide (Co₂O₃), vanadium oxide (V₂O₇), antimony oxide (Sb₂O₃) with the same content (i.e., 0.1 to 7 wt %).

Besides, other than the materials above, the dielectric material may contain the following lead-free materials with no specific limitation in content of the material composition: 0 to 40 wt % zinc oxide (ZnO); 0 to 35 wt % boric oxide (B₂O₃); 0 to 15 wt % silicon oxide (SiO₂); and 0 to 10 wt % aluminum oxide (Al₂O₃).

The dielectric material with the material composition above is ground, by a wet jet mill or a ball mill, into the form of grains having an average diameter ranging from 0.5 to 2.5 μm. The dielectric material powder is thus prepared. Next, the dielectric material powder in a ratio of 55 to 70 wt % and a binder component in a ratio of 30 to 45 wt % are well mixed by a triple roll mill into the first dielectric layer paste to be the-coated or printed.

The binder component is made of ethylcellulose, terpineol having 1 to 20 wt % acrylic resin, or butylcarbitol acetate. For improvement in printing quality, the first dielectric material paste may contain a plasticizer and a dispersant when necessary as follows: as for the plasticizer, at least any one of dioctyl phthalate, dibutyl phthalate, and triphenyl phosphate, tributyl phosphate; as for the dispersant, at least any one of glycerol monooleate, sorbitan sesquioleate, HOMOGENOL (as the name of a Kao corporation product), and an alkylallyl phoshate.

Next, the first dielectric layer paste is printed by the-coating or screen printing on front glass substrate 3 so as to cover display electrodes 6 and dried. After that, the dried paste is baked at a temperature a little higher than the softening point of the dielectric material: ranging from 575° C. to 590° C.

Next will be described second dielectric layer 82. The dielectric material of second dielectric layer 82 has the following material composition: 11 to 20 wt % bismuth oxide (Bi₂O₃); 1.6 to 21 wt % at least any one of calcium oxide (CaO), strontium oxide (SrO), and barium oxide (BaO); and 0.1 to 7 wt % at least any one of molybdenum oxide (MoO₃), tungsten oxide (WO₃), and cerium oxide (CeO₂).

The dielectric material of second dielectric layer 82 may contain 0.1 to 7 wt % at least any one of copper oxide (CuO), chrome oxide (Cr₂O₃), cobalt oxide (Co₂O₃), vanadium oxide (V₂O₇), antimony oxide (Sb₂O₃), and manganese oxide (MnO2), instead of the aforementioned group having molybdenum oxide (MoO₃), tungsten oxide (WO₃), cerium oxide (CeO₂).

Besides, other than the materials above, the dielectric material may contain the following lead-free materials with no specific limitation in content of the material composition: 0 to 40 wt % zinc oxide (ZnO); 0 to 35 wt % boric oxide (B₂O₃); 0 to 15 wt % silicon oxide (SiO₂); and 0 to 10 wt % aluminum oxide (Al₂O₃).

The dielectric material with the material composition above is ground, by a wet jet mill or a ball mill, into the form of grains having an average diameter ranging from 0.5 to 2.5 μm. The dielectric material powder is thus prepared. Next, the dielectric material powder in a ratio of 55 to 70 wt % and a binder component in a ratio of 30 to 45 wt % are well mixed by a triple roll mill into the second dielectric layer paste to be die-coated or printed.

The binder component is made of ethylcellulose, terpineol having 1 to 20 wt % acrylic resin, or butylcarbitol acetate. For improvement in printing quality, the second dielectric material paste may contain a plasticizer and a dispersant when necessary as follows: as for the plasticizer, at least any one of dioctyl phthalate, dibutyl phthalate, and triphenyl phosphate, tributyl phosphate; as for the dispersant, at least any one of glycerol monooleate, sorbitan sesquioleate, HOMOGENOL (as the name of a Kao corporation product), and an alkylallyl phoshate.

Next, the second dielectric layer paste is printed by screen printing or die-coating on first dielectric layer 81 and dried. After that, the dried paste is baked at a temperature a little higher than the softening point of the dielectric material: ranging from 550° C. to 590° C.

For providing proper visible light transmission, the film thickness of dielectric layer 8 as the total of first dielectric layer 81 and second dielectric layer 82 should preferably be 41 μm or less. First dielectric layer 81 contains 20 to 40 wt % bismuth oxide (Bi₂O₃)—which is higher than that of second dielectric layer 82—so as to suppress reaction with silver (Ag) contained in metallic bus electrodes 4b, 5b. The higher Bi₂O₃-content allows first dielectric layer 81 to have a visible light transmission rate lower than that of second dielectric layer 82. From the reason, the film thickness of first dielectric layer 81 is determined to be smaller than that of second dielectric layer 82.

A bismuth oxide (Bi₂O₃)-content less than 11 wt % allows second dielectric layer 82 to improve resistance to tarnish, but at the same time, bubbles are easily generated in second dielectric layer 82 due to the lower Bi2O3-content. Similarly, a Bi₂O₃-content more than 40 wt % allows first dielectric layer 81 to be less resistant to tarnish. Therefore, it is not preferable to improve the transmission rate.

Besides, smaller film thickness of dielectric layer 8 provides a noticeable improvement in panel luminance and decrease in discharge voltage. It is therefore preferable that the film thickness should be minimized within a range where insulation voltage has no decrease. Taking it into consideration, the exemplary embodiment of the present invention defines the range of film thickness of each dielectric layer as follows: 5 to 15 μm for first dielectric layer 81 and 20 to 36 μm for second dielectric layer 82 in a range of the film thickness of dielectric layer 8 that does not exceed 41 μm.

According to the PDP with the material composition above, silver (Ag) contained in display electrodes 6 has little contribution to yellowish discoloring of front glass substrate 3, at the same time, dielectric layer 8 has free from bubbles. That is, the structure of the embodiment provides dielectric layer 8 with high insulation voltage.

Next will be described how the dielectric materials above prevent first dielectric layer 81 from yellowish discoloring and generation of bubbles. It is a known fact that adding molybdenum oxide (MoO₃) or tungsten oxide (WO₃) to dielectric glass containing bismuth oxide (Bi₂O₃) easily generates the following chemical compounds at a low temperature not exceeding 580° C.: Ag₂MoO₄, Ag₂Mo₂O₇, Ag₂Mo₄O₁₃, Ag₂WO₄, Ag₂W₂O₇, and Ag₂W₄O₁₃. According to the embodiment of the present invention, dielectric layer 8 is formed by baking at a temperature ranging from 550° C. to 590° C. In the baking process, silver ions (Ag⁺) dispersed in dielectric layer 8 undergo reactions with molybdenum oxide (MoO₃), tungsten oxide (WO₃), cerium oxide (CeO₂), and manganese dioxide (MnO2) and become stable as result of forming stable chemical compounds. That is, silver ions (Ag⁺) become stable without reduction and therefore have no flocculated colloid, reducing oxygen generated with the colloid formation of silver (Ag). This allows dielectric layer 8 to have little bubbles.

To ensure the effects above, it is preferable that the content of molybdenum oxide (MoO₃), tungsten oxide (WO₃), cerium oxide (CeO₂), and manganese dioxide (MnO₂) in the dielectric glass containing bismuth oxide (Bi₂O₃) should be not less than 0.1 wt %; more preferable, not less than 0.1 wt % and not more than 7 wt %. The content lower than 0.1 wt % is not effective in suppressing yellowish discoloring; on the other hand, the content exceeding 7 wt % causes unwanted change in color of glass.

In consideration of making contact with metallic bus electrodes 4b, 5b formed of silver (Ag)-based material, first dielectric layer 81 of dielectric layer 8 of the PDP in the embodiment is structured of proper material composition, by which the yellowish discoloring and the generation of bubbles are suppressed. In addition, forming second dielectric layer 82 on first dielectric layer 81 achieves high light-transmission rate of dielectric layer 8. In this way, the PDP of the embodiment has an excellent structure of dielectric layer 8 in which bubbles and discoloring seldom occur and light transmission rate is remarkably improved.

Next will be described the structure of the protective layer and the method for manufacturing thereof as a distinctive feature of the PDP of the exemplary embodiment.

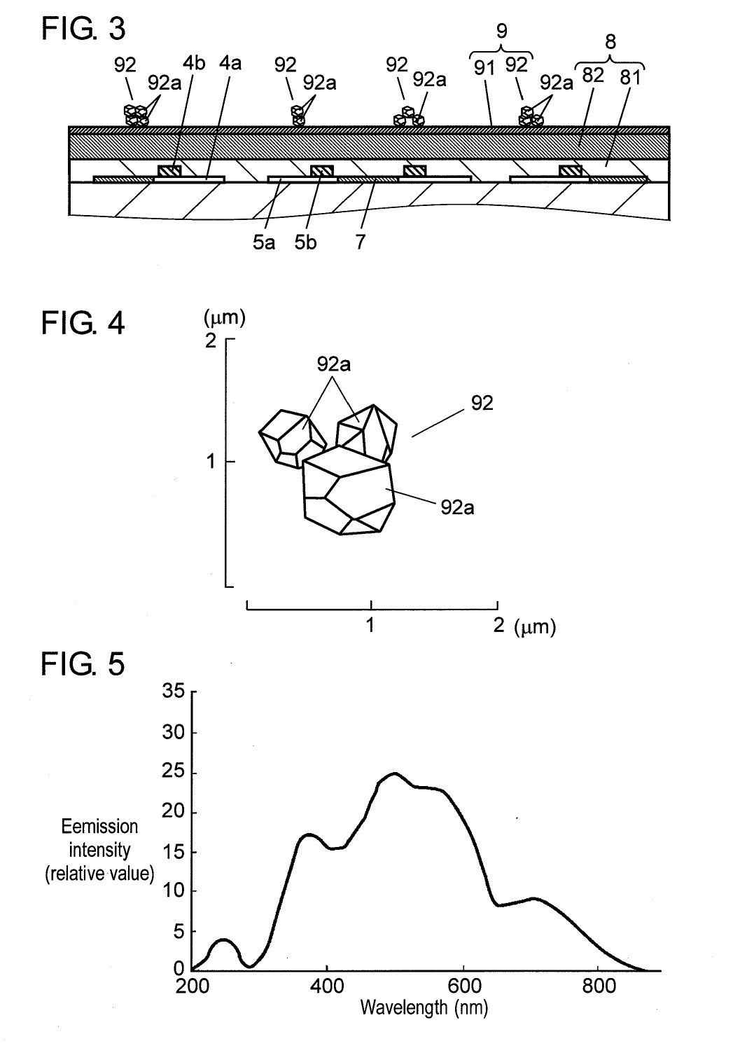

According to the PDP of the embodiment, as shown in FIG. 3, protective layer 9 has the following structure. First, base-coat film 91 made of MgO containing Al as an impurity is formed on dielectric layer 8. Next, agglomerated particles 92, which are formed of crystal particles 92a of MgO as a metal oxide, are dispersed so as to have a uniform distribution all over the surface of base-coat film 91.

Agglomerated particles 92 are formed of, as shown in FIG. 4, crystal particles 92a with a predetermined primary particle diameter aggregated or necked together. They are not connected with a strong bond like a solid but constitute an aggregate of a plurality of primary particles bound with static electricity or Van der Waals' forces. Therefore, with the application of external stimulus, such as ultrasound, the aggregate partly or wholly goes back to each primary particle. Each of agglomerated particles 92 has a particle diameter of approx. 1 μm. Preferably, crystal particles 92a should be formed into a polyhedron having seven sides or more, for example, a cuboctahedron or a dodecahedron.

The primary particle diameter of MgO-crystal particles 92a can be controlled by the condition under which crystal particles 92a are produced. For example, when crystal particles 92a are produced by baking an MgO-precursor, such as magnesium carbonate and magnesium hydrate, the particle diameter can be controlled by baking temperature and baking atmosphere. The baking temperature generally ranges from approx. 700° C. to 1500° C. Baking the precursor at a relatively high temperature, i.e., at 1000° C. or higher allows the primary particle to have a primary particle diameter of approx. 0.3 to 2 μm. Besides, forming crystal particles 92a from the MgO-precursor with application of heat allows agglomerated particles 92 to have a structure in which a plurality of primary particles are aggregated or necked with each other in the forming process.

Next will be described the result of experiment for demonstrating the effect of the PDP employing the protective layer of the exemplary embodiment of the present invention.

First, the inventors prepared four PDP-samples each of which has a differently structured protective layer. Sample 1 employs a protective layer made of MgO. Sample 2 employs a protective layer made of MgO in which impurities, such as Al and Si, are doped. Sample 3 employs a protective layer having MgO base-coat film 91 on which only primary particles of crystal particles made of metal oxide are dispersed and attached. Sample 4 employs the protective layer of the present invention. As described above, crystal particle paste, which is made of agglomerated particles and a dispersing solvent, is applied on MgO base-coat film 91 to form a crystal-particle-paste film. After that, the crystal-particle-paste film is baked together with the base-coat film, by which the crystal particles are aggregated and evenly distributed all over the base-coat film. The agglomerated particles are a plurality of aggregated crystal particles made of metal oxide. The dispersing solvent is for dispersing the agglomerated particles and is classified in any one of an aliphatic alcohols solvent having ether binding and an alcohols solvent larger than dihydric alcohol. In samples 3 and 4, single-crystal particles of MgO are used as metal oxide. The inventors measured cathode luminescence of the crystal particles employed for the sample 4 of the embodiment. The crystal particles exhibit emission intensity characteristic to the wavelengths shown in FIG. 5 (where, the emission intensity is represented by relative values). The inventors carried out the experiment on characteristics of electron emission and charge retention of the PDP samples with four differently structured protective layers.

The electron emission characteristic is represented by the emission amount of initial electrons that depends on discharge surface condition, the type of gas, and the condition of the gas. The greater the measured value, the larger the amount of electron emission. The amount of initial electron emission can be measured by an amount of electron current emitted from the surface of the front panel in response to irradiation of ions or electron beams to the surface. However, there is a difficulty in nondestructive evaluation of the surface of the front plate. Here in the embodiment, the emission amount of initial electrons is estimated by the method introduced in Japanese Unexamined Patent Application Publication No. 2007-48733. According to the method, a statistical delay time in a delay time at discharge is obtained. The value of the statistical delay time is used as an indicator of estimating the discharge-prone state. The integral of the reciprocal of the value represents a value corresponding to the amount of initial electron emission and a linear shape. The electron emission amount in the embodiment is evaluated from the calculated value above. The delay time at discharge represents the time lag between the pulse rise-time and a time at which a discharge occurs with delay. When the initial electrons that trigger a discharge are poorly emitted from the surface of the protective layer into the discharge space, discharge delay is very likely. This is considered as the major factor of discharge delay.

To evaluate the charge retention characteristic of the samples, a value of voltage applied to the scan electrodes (hereinafter, Vscn lighting voltage)—which is required for suppressing charge emission in a completed product as a PDP—was used as an indicator. That is, the lower the value of Vscn lighting voltage, the greater the charge retention characteristic. This is advantageous to the panel design of a PDP, allowing the PDP to have power supply and electric parts with low breakdown-voltage and capacity. In the currently marketed products, an element having a breakdown voltage of approx. 150V is used for a semiconductor switching element, such as MOSFET, to sequentially apply scan voltage to the panel. Therefore, it is preferable that Vscn lighting voltage should be 120V or less in consideration of variation caused by temperatures.

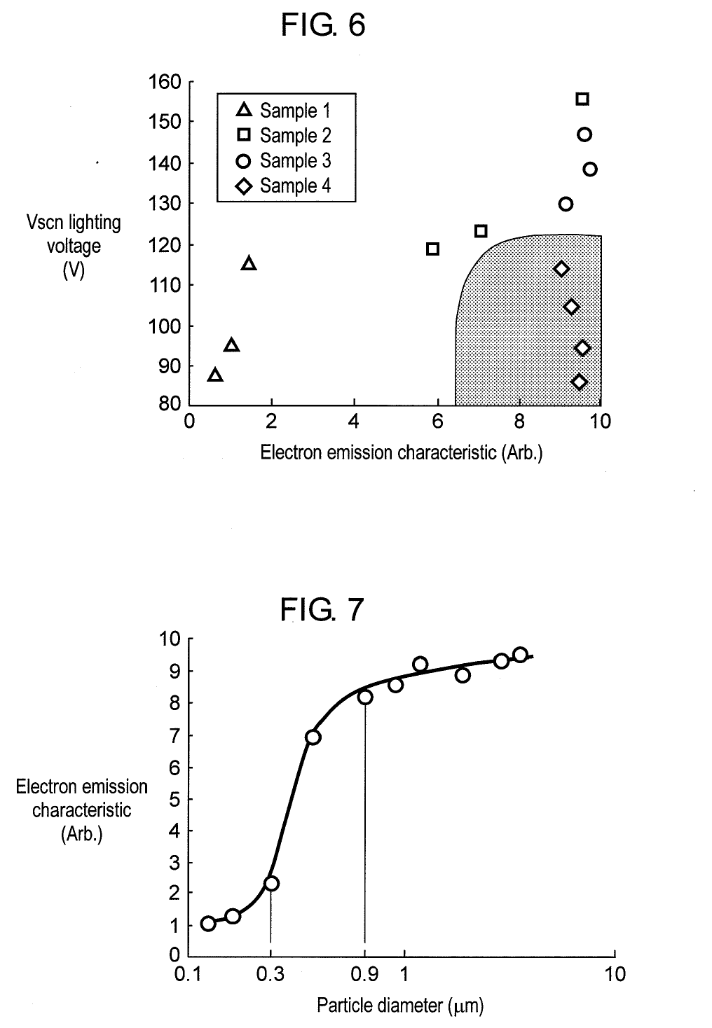

FIG. 6 shows the result of evaluating the characteristics of electron emission and charge retention. As is apparent from FIG. 6, sample 4 achieves favorable result on both of the characteristics: Vscn lighting voltage not more than 120V and electron emission not less than 6.

In general, the electron emission and the charge retention of the protective layer of a PDP are characteristics in trade-off. For example, changing condition for forming the film of the protective layer or forming the film with impurities, such as Al, Si, and Ba, doped into the protective layer contribute to improvement in electron emission characteristic; but at the same time, which inconveniently increase Vscn lighting voltage.

However, the PDP having protective layer 9 of the exemplary embodiment offers excellent result: electron emission not less than 6 and Vscn lighting voltage not more than 120V. As described earlier, the technology progress on high-definition allows a PDP to have increase in number of scanning lines and decrease in size of a cell. The structure of the exemplary embodiment allows the protective layer of such an advanced PDP to have satisfactory characteristics both in electron emission and charge retention.

Next will be described the particle diameter of a crystal particle used for protective layer 9 of the PDP of the exemplary embodiment of the present invention. Throughout the description below, the particle diameter represents an average particle diameter, specifically, a volume cumulative average diameter (D50).

FIG. 7 shows the result of the experiment on the electron emission characteristic of sample 4 of the present invention explained in FIG. 6, with the particle diameter of an MgO-crystal particle changed. In the experiment, the particle diameter of the MgO-crystal particle of FIG. 7 was measured by observing the particle with a scanning electron microscope (SEM). FIG. 7 shows poor electron emission at a particle diameter of approx. 0.3 μm, on the other hand, excellent electron emission at a particle diameter of approx. 0.9 μm or greater.

To increase the number of electron emission in a discharge cell, the number of crystal particles 92a per unit area in base-coat film 91 should preferably be increased. According to the experiment by the inventors, if crystal particles 92a are attached at a section of protective layer 9 of front plate 2 that makes intimate contact with the top section of barrier rib 14 of rear plate 10, it can break the top section of barrier rib 14. Further, if the broken material of the barrier rib puts on phosphor layer 15, the cell corresponding to the phosphor layer may not properly light on/off. The barrier-rib breakage hardly occurs as long as the crystal particles are not disposed in the area that meets with the top section of the barrier rib. In other words, the greater the number of the crystal particles attached to the protective layer, the higher the frequency of the barrier-rib damage.

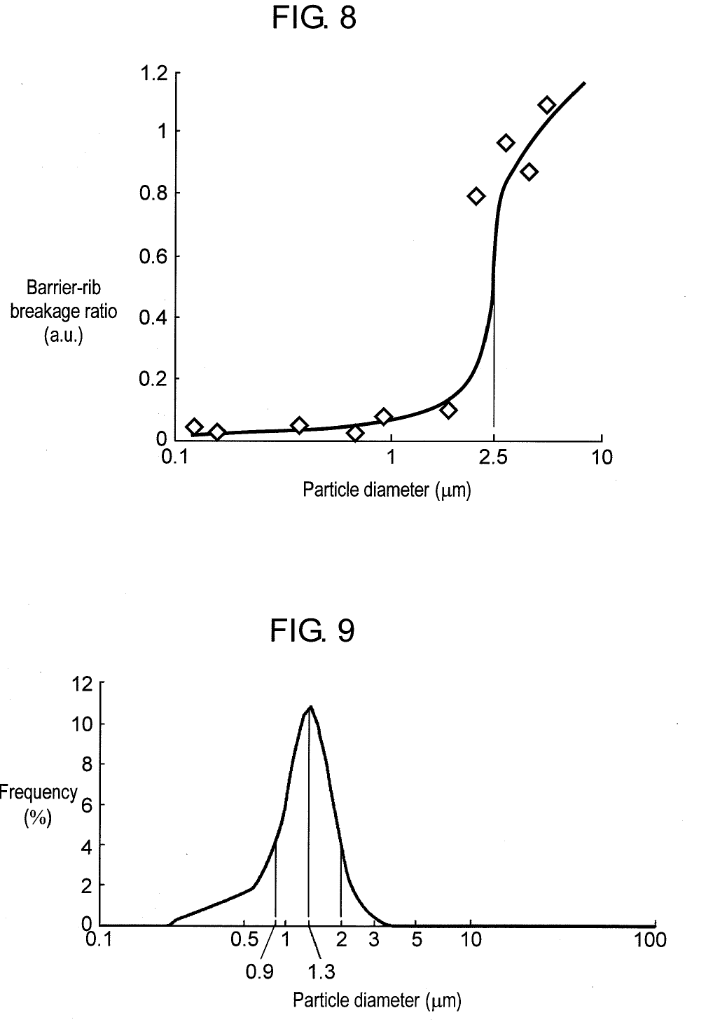

To find relationship between barrier-rib breakage ratio and the particle diameter, the inventors carried out an experiment on sample 4 shown in FIG. 6 of the exemplary embodiment. In the experiment, the crystal particles dispersed per unit area are the same in number but different in particle diameter. FIG. 8 shows the experiment result.

As is apparent from FIG. 8, employing a crystal particle with a particle diameter of 2.5 μm or greater invites drastic increase in barrier-rib breakage; on the other hand, the breakage ratio is relatively small when the particle diameter is kept 2.5 μm or smaller.

From the result above, crystal particles 92a with a particle diameter ranging from 0.9 to 2.5 μm are preferably employed for protective layer 9 of the PDP of the exemplary embodiment. However, from the viewpoint of practical PDP volume production, there is a necessity to consider variations not only in crystal particles 92a but also in protective layer 9 in the manufacturing process.

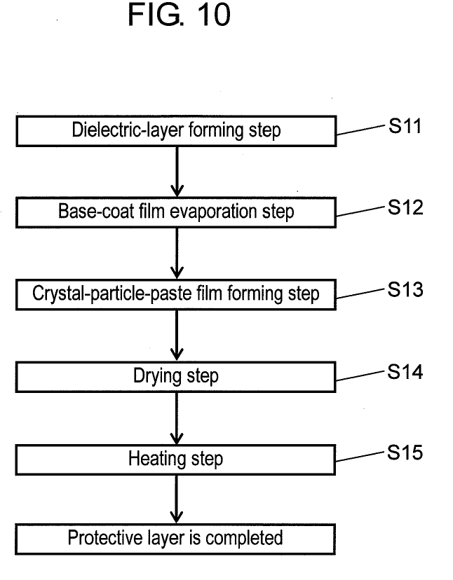

To take above into consideration, the inventors carried out an experiment on crystal particles with different particle diameters. FIG. 9 shows the particle diameter of the crystal particle as an example and a frequency of presence of the crystal particle having the particle diameter. FIG. 9 apparently shows that the effect of the present invention is consistently obtained by employing crystal particles with an average particle diameter ranging from 0.9 to 2.0 μm inclusive.

As described above, the PDP having the protective layer of the present invention achieves the electron emission characteristic of 6 or greater and Vscn lighting voltage of 120V or less as the charge retention characteristic.

As described earlier, the technology progress on high-definition allows a PDP to have increase in number of scan lines and decrease in size of a cell. Under the circumstance, the protective layer of the present invention satisfies both characteristics of electron emission and charge retention. This provides a PDP with excellent display performance with not only high definition and high luminance but also low power consumption.

Next will be described the steps of manufacturing the protective layer of the PDP of the embodiment with reference to FIG. 10.

As shown in FIG. 10, dielectric layer 8 with a layered structure of first dielectric layer 81 and second dielectric layer 82 is formed in dielectric-layer forming step S11. After that, in base-coat film evaporation step S12, MgO-sintered body containing Al is applied on dielectric layer 8 by vacuum evaporation method, by which MgO base-coat film is formed on second dielectric layer 82 of dielectric layer 8.

In crystal-particle-paste film forming step S13, a plurality of crystal particles are dispersed over the non-baked base-coat film formed in base-coat film evaporation step S12. In step S13, firstly, crystal-particle paste is prepared as follows. Crystal particles 92a with a predetermined particle-size distribution are mixed, together with a resin component, into dispersing solvent (where, the dispersing solvent is the one classified into any one of an aliphatic alcohols solvent having ether binding and an alcohols solvent larger than dihydric alcohol). Such structured crystal-particle paste is applied onto the non-baked base-coat film by screen printing or the following methods: spraying, spin coating, die coating, and slit coating.

The crystal-particle paste film formed above is dried in drying step S14.

In heating step S15, the crystal-particle paste film, which has been formed in S13 and then dried in S14, is baked with the non-baked base-coat film that has been formed in S12 at a temperature of several hundred ° C. The baking process removes a residue of the solvent and resin component from the crystal-particle paste film, with a plurality of agglomerated particles 92 left on base-coat film 91 of protective layer 9.

Next will be described the solvent used for the crystal-particle paste of the present invention. The inventors carried out an experiment on dispersibility of MgO crystal-particle in sample 4 described in FIG. 6. The dispersibility was examined in a manner that MgO crystal-particles are dispersed into the paste with the use of various types of solvent. Using each solvent, the inventors prepared 1 wt %-MgO crystal-particle dispersed liquid and brought it into a well-saturated state by an ultrasonic disperser for examining the particle diameter.

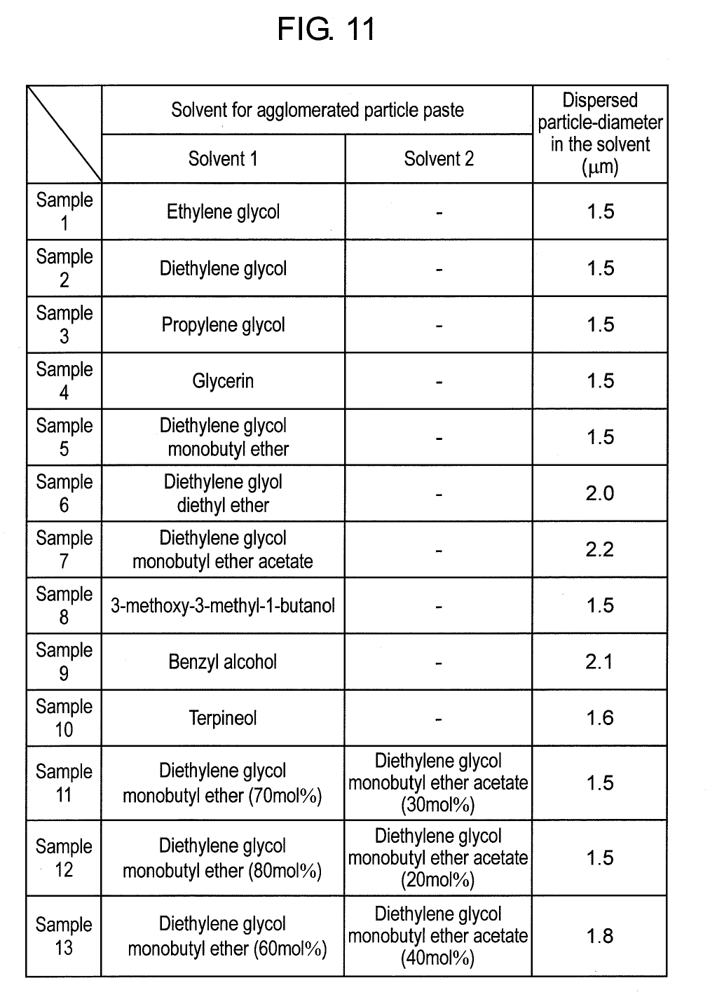

As shown in FIG. 11, the result of the experiment on samples 1 through 4 shows that using an alcohols solvent larger than dihydric alcohol, such as ethylene glycol, diethylene glycol, propylene glycol, and glycerin, achieves good dispersibility. The result of the experiment on samples 5 through 10 shows that using an aliphatic alcohols solvent having ether binding, such as diethylene glycol monobutyl ether, diethylene glycol diethyl ether, diethylene glycol monobutyl ether acetate, 3-methoxy-3-methyl-1-butanol, benzyl alcohol, and terpineol, achieves good dispersibility. Non-alcohol and aromatic alcohol offers poor dispersibility. Besides, the solvent is not necessarily limited to single use. The result of the experiment on samples 11 through 13 shows that mixing a solvent—even if it offers poor dispersibility—with the one having good dispersibility achieves a good result.

As described above, using a dispersing solvent classified into any one of an aliphatic alcohols solvent having ether binding and an alcohols solvent larger than dihydric alcohol allows crystal-particle paste with good dispersibility. That is, with the use of the paste, the favorable effect of the present invention can be obtained with consistency. A resin component may not be used in spraying and slit coating that do not necessarily require it.

The description above has been given on MgO protective layer 9 as an example. The feature primarily desired for the base coat is high resistance to sputtering for protecting dielectric material from ion bombardment. That is, a highest degree of the electron emission characteristic is not demanded for the base coat. In most cases, to maintain both the characteristics of electron emission and sputtering resistance higher than a predetermined level, conventional PDPs have employed the protective layer mainly formed of MgO. However, according to the structure of the present invention, the electron emission characteristic dominantly depends on a single-crystal particle of metal oxide. Therefore, instead of MgO, the base coat may be made of Al₂O₃ or other materials with high resistance to impact.

Although the description above has been given on an example where MgO-particles are used for the crystal particle, it is not limited to. When other single-crystal particles, such as Sr, Ca, Ba, and Al of metal oxides with the electron emission characteristic as high as MgO, are used, the present invention offers the similar effect.

In manufacturing PDPs, there has been an attempt to improve the electron emission characteristic by mixing impurities into the protective layer. According to a conventional PDP, however, mixing impurities into the protective layer allows a PDP to have improvement in the electron emission characteristic, but at the same time, allows the PDP to have electric charge built up on the surface of the protective layer, by which attenuation rate—the rate of decrease in charge to be used for a memory function as time goes by—is increased. To address above, increase in application voltage or other measures has to be taken. Conventional PDPs have faced the difficulty that the protective layer has to satisfy two characteristics in trade-off: high electron-emission and high charge-retention i.e., lowered attenuation ratio of charge used for the memory function.

On the other hand, as is apparent from the description above, the PDP of the present invention has improved electron-emission characteristic, as well as charge-retention characteristic, providing high quality of images, low cost, and low voltage operations. This allows the PDP to have display performance with high resolution, high luminance, and low power consumption.

Besides, the manufacturing method of the present invention allows a plurality of agglomerated particles to be distributed nearly evenly all over the surface of the base-coat film.

### INDUSTRIAL APPLICABILITY

As described above, the present invention is useful for providing a PDP having display performance with high resolution, high luminance, and low power consumption.

1. A method for manufacturing a plasma display panel
wherein, the panel having:
a front plate in which a dielectric layer is formed so as to cover display electrodes, and a protective layer is formed on the dielectric layer; and
a rear plate disposed opposite to the front plate so as to form discharge space therebetween, the rear plate in which an address electrode is formed so as to be orthogonal to the display electrodes and a barrier rib for dividing the discharge space,
the method comprising:
evaporating a base-coat film for the protective layer onto the dielectric layer;
forming crystal-particle paste on the base-coat film by applying crystal-particle paste in which a plurality of crystal particles of metal oxide is dispersed in a solvent classified into any one of an aliphatic alcohols solvent having ether binding and an alcohols solvent larger than dihydric alcohol; and
removing the solvent by heating the crystal-particle paste film so that the plurality of crystal particles are distributed over an entire surface of the protective layer.

2. The method for manufacturing a plasma display panel of claim 1, wherein an average particle diameter of the crystal particles is not less than 0.9 μm and not more than 2 μm.

3. The method for manufacturing a plasma display panel of claim 1, wherein the base-coat film is made of MgO.
